(19) United States
(12) Patent Application Publication
(10) Pub. No.: US 2010/0321428 A1
(43) Pub. Date: Dec. 23, 2010

(54) DOT RECORDING DEVICE, DOT RECORDING METHOD, AND STORAGE MEDIUM STORING COMPUTER PROGRAM

(75) Inventors: Toshiki Saito, Matsumoto-shi (JP); Hironori Matsuoka, Shiojiri-shi (JP)

Correspondence Address: NUTTER MCCLENNEN & FISH LLP, SEAPORT WEST, 155 SEAPORT BOULEVARD, BOSTON, MA, 02210-2604, US

(73) Assignee: SEIKO EPSON CORPORATION, Tokyo (JP)

(21) Appl. No.: 12/785,637

(22) Filed: May 24, 2010

(30) Foreign Application Priority Data
Jun. 22, 2009 (JP) 2009-147341

(51) Int. Cl. B41J 29/38

(52) U.S. Cl. 347/9

(57) ABSTRACT

A storage medium storing a computer program that can be read by a computer, wherein the computer program causes the computer to generate dot recording data that is used in order for a dot recording device to perform dot recording and is supplied to the dot recording device that alternately performs, on the basis of the dot recording data, a main scanning pass to record a dot on a recording medium while moving an output head in a main scanning direction, the output head having a plurality of nozzles arranged in an auxiliary scanning direction, and a transfer operation to move the recording medium in the auxiliary scanning direction and that forms, on the recording medium, raster lines that extend in the main scanning direction and are arranged in the auxiliary scanning direction; when an M×N number of dots that are arranged in an M number of the raster lines and an N number of columns in a dot recording region are to be recorded in an M×N number of main scanning passes, the computer program causes the computer to perform a function of selecting, in the order in which the dots are recorded and on the basis of a thinning rate and of data on set recording positions of the dots that are to be recorded in the main scanning passes, a dot to be thinned from among the M×N number of dots included in the dot recording region so that the order in which dots arranged in each of the entire columns of the dot recording region in the auxiliary scanning direction are recorded is not sequential, each of M and N being an integer of two or more, the M number of raster lines being continuously arranged in the auxiliary scanning direction, the N number of columns being continuously arranged in the main scanning direction; the computer program causes the computer to perform a function of performing a thinning process on the dot to be thinned to thin the dot and prevent the dot from being recorded; and the computer program causes the computer to perform a function of forming the dot recording data by repeatedly arranging, in the main and auxiliary scanning directions, the dot recording region including the dot that is selected in the order in which the dots are recorded and is to be thinned.

### BACKGROUND

1. Technical Field

The present invention relates to a technique for recording a dot on a dot recording medium.

2. Related Art

A typical device that outputs a color material such as ink to perform dot recording is an inkjet printer. There is a demand for an inkjet printer that uses a reduced amount of ink and that has improved cost performance. There is a method for thinning ink dots to reduce the amount of ink consumed (e.g., JP-A-2001-30522).

In the method for thinning ink dots, however, the quality of an image is significantly degraded due to a reduction in printing density. This problem occurs not only in inkjet printers, but also in color material output devices that output a color material to record a dot on a dot recording medium.

### SUMMARY

An advantage of some aspects of the invention is that it provides a technique for reducing the amount of a color material used to record a dot without excessive degradation in the quality of an image.

The invention has been devised to solve at least a part of the aforementioned problem and can be realized in the following embodiments and aspects.

### Dot Data Generator

According to a first aspect of the invention, a dot data generator generates dot recording data to be used to select recording positions of dots that are to be recorded on a recording medium by a dot recording device and includes: an output section that outputs the dot recording data to the dot recording device that alternately performs, on the basis of the dot recording data, a main scanning pass to record a dot on a recording medium while moving an output head in a main scanning direction, the output head having a plurality of nozzles arranged in an auxiliary scanning direction, and a transfer operation to move the recording medium in the auxiliary scanning direction and forms, on the recording medium, raster lines that extend in the main scanning direction and are arranged in the auxiliary scanning direction; and a thinning processing section that performs a thinning process on a dot to be thinned to thin the dot and prevent the dot from being recorded, wherein when an M×N number of dots that are arranged in a an M number of the raster lines and an N number of columns in a dot recording region are to be recorded in an M×N number of main scanning passes, the output section sets the recording positions of the dots that are to be recorded in the main scanning passes so that the order in which dots arranged in each of the entire columns of the dot recording region in the auxiliary scanning direction are recorded is not sequential, and the output section outputs the dot recording data, each of M and N being an integer of two or more, the M number of raster lines being continuously arranged in the auxiliary scanning direction, the N number of columns being continuously arranged in the main scanning direction; and the thinning processing section that selects, in the order in which the dots are recorded and on the basis of a thinning rate, the dot to be thinned from among the M×N number of dots included in the dot recording region.

The dot data generator having the aforementioned configuration treats the dot recording region including the M×N number of dots arranged in the M number of raster lines and the N number of columns arranged in the main scanning direction as a composition unit of the dot recording data. The M×N number of dots included in the dot recording region are sequentially recorded on the recording medium in the M×N number of main scanning passes in the order of the main scanning passes. The dot data generator selects, on the basis of the thinning rate, the dot to be thinned from among the M×N number of dots included in the dot recording region. The dot data generator performs the thinning process on the selected dot to thin the dot and prevent the dot from being recorded. Loads of the nozzles can be reduced since the nozzles do not need to output a color material for the thinned dot. In addition, the amount of the color material output from the nozzles can be reduced.

When the dot recording region is to be recorded in the M×N number of main scanning passes, the dot data generator having the aforementioned configuration sets the recording positions of the dots so that the order in which the dots arranged in each of the entire columns of the dot recording region in the auxiliary scanning direction are recorded is not sequential. Thus, the recording positions of the dots that are included in the dot recording region and are to be recorded can be set so that the order in which dots arranged in the raster lines adjacent to each other in the auxiliary scanning direction are recorded is sequential. The number of each of the main scanning passes is represented by a pass number. The dots that are not thinned and are selected from among the dots represented by the pass numbers of the M×N number of main scanning passes remain on the raster lines corresponding to the main scanning lines adjacent to each other. Thus, the amounts of errors in feeding of the recording medium in the auxiliary scanning direction, which accumulate with every main scanning pass performed to record the dots on the adjacent raster lines, can be reduced. As a result, the quality of an image is not excessively degraded, and the amount of the color material used can be reduced.

The dot data generator selects, in the order in which the dots are recorded and on the basis of the thinning rate, the dot to be thinned from among the M×N number of dots included in the dot recording region in order to perform the thinning process. Thus, the dot is thinned in the order in which the dots are recorded, while the number of dots to be thinned is determined on the basis of the thinning rate. Therefore, the thinning process may be performed with various thinning rates. In the thinning process with each of the thinning rates, degradation in the quality of an image can be suppressed and the amount of the color material used can be reduced. The dot to be thinned may be selected in ascending dot recording order from the dot that is included in the dot recording region and is to be first recorded according to the order in which the dots are recorded or in descending dot recording order from the dot that is included in the dot recording region and is to be the last recorded according to the order in which the dots are recorded.

The dot recording data is formed by repeatedly arranging, in the main and auxiliary scanning directions, the dot recording region including the dot that is selected in the order in which the dots are recorded and is to be thinned. The formed dot recording data may be output to the dot recording device. The dot recording device that receives the dot recording data can perform dot recording so that degradation in the quality of an image is suppressed and the amount of the color material used is reduced. The dot recording region is repeatedly arranged in the main scanning direction on the dot recording data, while the order in which the dots included in each dot recording region are recorded is the same. Thus, calculation loads necessary to select a dot to be thinned and form the dot recording data can be reduced. In addition, processing for the selection and processing for the data formation can be performed at high-speed.

According to the invention, a dot recording device has the following configuration.

According to a second aspect of the invention, the dot recording device that alternately performs, on the basis of dot recording data, a main scanning pass to record a dot on a recording medium while moving an output head in a main scanning direction, the output head having a plurality of nozzles arranged in an auxiliary scanning direction, and a transfer operation to move the recording medium in the auxiliary scanning direction and forms, on the recording medium, raster lines that extend in the main scanning direction and are arranged in the auxiliary scanning direction includes: a dot recording setting section that sets recording positions of dots that are to be recorded in main scanning passes so that the order in which dots arranged in each entire column of a dot recording region in the auxiliary scanning direction are recorded is not sequential when an M×N number of the dots that are arranged in an M number of the raster lines and an N number of the columns in the dot recording region are to be recorded in an M×N number of the main scanning passes, each of M and N being an integer of two or more, the M number of raster lines being continuously arranged in the auxiliary scanning direction, the N number of columns being continuously arranged in the main scanning direction; a thinning processing section that performs a thinning process on a dot to be thinned to thin the dot and prevent the dot from being recorded; and a dot data generator that generates the dot recording data subjected to the setting by the dot recording setting section and to the thinning process by the thinning processing section, wherein the thinning processing section selects, in the order in which the dots are recorded and on the basis of a thinning rate, the dot to be thinned from among the M×N number of dots included in the dot recording region; and the dot data generator forms the dot recording data by repeatedly arranging, in the main and auxiliary scanning directions, the dot recording region including the dot that is selected in the order in which the dots are recorded and is to be thinned.

In this case, the dot recording device may be an inkjet printer.

According to the invention, a dot recording method is performed as follows.

According to a third aspect of the invention, the dot recording method includes: alternately performing, on the basis of dot recording data, a main scanning pass to record a dot on a recording medium while moving an output head in a main scanning direction, the output head having a plurality of nozzles arranged in an auxiliary scanning direction, and a transfer operation to move the recording medium in the auxiliary scanning direction and forming, on the recording medium, raster lines that extend in the main scanning direction and are arranged in the auxiliary scanning direction; when an M×N number of dots that are arranged in an M number of the raster lines and an N number of columns in a dot recording region are to be recorded in an M×N number of main scanning passes, setting recording positions of the dots that are to be recorded in the main scanning passes so that the order in which dots arranged in each of the entire columns of the dot recording region in the auxiliary scanning direction are recorded is not sequential, each of M and N being an integer of two or more, the M number of raster lines being continuously arranged in the auxiliary scanning direction, the N number of columns being continuously arranged in the main scanning direction; selecting, in the order in which the dots are recorded and on the basis of a thinning rate, a dot to be thinned from among the M×N number of dots included in the dot recording region; performing a thinning process on the dot to be thinned to thin the dot and prevent the dot from being recorded; and forming the dot recording data by repeatedly arranging, in the main and auxiliary scanning directions, the dot recording region including the dot that is selected in the order in which the dots are recorded and is to be thinned.

According to the invention, a computer program has the following configuration.

According to a fourth aspect of the invention, the computer program causes a computer to generate dot recording data that is used in order for a dot recording device to perform dot recording and is supplied to the dot recording device that alternately performs, on the basis of the dot recording data, a main scanning pass to record a dot on a recording medium while moving an output head in a main scanning direction, the output head having a plurality of nozzles arranged in an auxiliary scanning direction, and a transfer operation to move the recording medium in the auxiliary scanning direction and forms, on the recording medium, raster lines that extend in the main scanning direction and are arranged in the auxiliary scanning direction, wherein when an M×N number of dots that are arranged in an M number of the raster lines and an N number of columns in a dot recording region are to be recorded in an M×N number of main scanning passes, the computer program causes the computer to perform a function of setting recording positions of the dots that are to be recorded in the main scanning passes so that the order in which dots arranged in each of the entire columns of the dot recording region in the auxiliary scanning direction are recorded is not sequential, each of M and N being an integer of two or more, the M number of raster lines being continuously arranged in the auxiliary scanning direction, the N number of columns being continuously arranged in the main scanning direction; the computer program causes the computer to perform a function of selecting, in the order in which the dots are recorded and on the basis of a thinning rate, a dot to be thinned from among the M×N number of dots in the dot recording region; the computer program causes the computer to perform a function of performing a thinning process on the dot to be thinned to thin the dot and prevent the dot from being recorded; and the computer program causes the computer to perform a function of forming the dot recording data by repeatedly arranging, in the main and auxiliary scanning directions, the dot recording region including the dot that is selected in the order in which the dots are recorded and is to be thinned.

The invention can be realized in various embodiments. For example, the invention may be applied to a storage medium storing a computer program that achieves a function of a printing method, a function of a printing device, a function of a color material output device, a function of a printing control method, or a function of a printing controller.

### BRIEF DESCRIPTION OF THE DRAWINGS

The invention will be described with reference to the accompanying drawings, wherein like numbers reference like elements.

FIG. 1 is a diagram showing the configuration of a printing system according to an embodiment of the invention.

FIG. 2 is a diagram showing a dot recording method according to the embodiment.

FIGS. 3A and 3B are diagrams showing types of ink dots that can be formed by an inkjet printer.

FIG. 4 is a diagram showing in detail the dot recording method illustrated in FIG. 2 in association with pass numbers of main scanning passes and nozzle numbers.

FIG. 5 is a diagram showing an arrangement of the pass numbers in a dot recording region DT.

FIGS. 6A to 6H are diagrams showing the contents of a thinning process according to the embodiment.

FIG. 7 is a diagram showing a difference between a thinning process in a comparative example and the thinning process according to the embodiment when a thinning rate used in the comparative example is the same as a thinning rate used in the embodiment.

FIG. 8 is a flowchart of a method for selecting, for each dot recording region DT, a dot to be thinned and generating dot recording data after the selection.

FIGS. 9A to 9H are diagrams corresponding to FIGS. 6A to 6H and showing the contents of a thinning process according to a first modified example.

FIGS. 10A to 10H are diagrams corresponding to FIGS. 9A to 9H and showing the contents of a thinning process according to a second modified example.

### DESCRIPTION OF EXEMPLARY EMBODIMENTS

An embodiment of the invention is described in the order of the configuration of a device, an example and modified examples.

### Configuration of Device

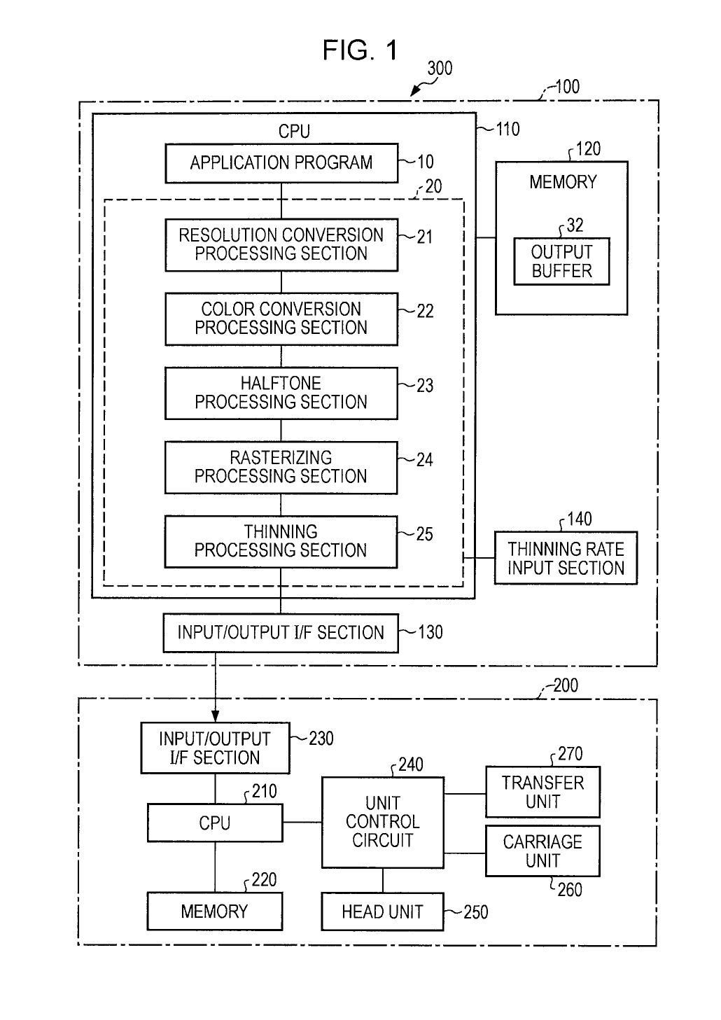

FIG. 1 is a diagram showing the configuration of a printing system according to the embodiment of the invention. The printing system 300 includes: a personal computer 100 that serves as an image processing device; and a printer 200 connected to the personal computer 100.

The personal computer 100 includes a CPU 110, a memory 120, an input/output interface (I/F) section 130 and a thinning rate input section 140. The memory 120 includes an output buffer 32. The output buffer 32 stores data (dot data) that is to be printed. In the embodiment, a dot group that includes dots arranged in four rows and two columns is treated as a dot recording region DT that is a dot composition unit. The thinning rate input section 140 selects a thinning rate from ⅛ to ⅞. The thinning rate is selected by a user. To maintain the quality of an image, the thinning rate is typically set to a range of ⅛ to 6/8. This is due to the fact that when the thinning rate of ⅞ is selected, the thinning rate may be excessively large.

Various computer programs including an application program 10 and a printer driver 20 are installed in the personal computer 100. The application program 10 and the printer driver 20 are executed under a predetermined operating system (not shown) by the CPU 110. The printer driver 20 may function in the personal computer 100. Alternatively, the printer driver 20 may function in the printer 200.

The application program 10 is executed to achieve an image editing function, for example. The user can give, through a user interface provided by the application program 10, an instruction to print an image edited by the application program 10. When the application program 10 receives the instruction from the user, the application program 10 outputs, to the printer driver 20, image data that is to be printed. In the embodiment, the image data is output as RGB data.

The printer driver 20 is a program designed to perform a function of generating data (to be printed) on the basis of the image data output from the application program 10. The data to be printed is in a form that can be interpreted by the printer 200. The data to be printed includes various command data and dot data. The command data is used to instruct the printer 200 to perform a specified operation. The dot data represents the states of dots to be formed in accordance with pixels that form an image that is to be printed. Specifically, the dot data represents the sizes and colors of the dots that are to be formed in accordance with the pixels (or represents that a dot is not to be formed in accordance with at least one of the pixels). The “dot” is regarded as being a single ink region formed by ink output from the printer 200 landing on a printing medium.

The printer driver 20 has a function of converting the image data output from the application program 10 into data that is to be printed. The printer driver 20 includes a resolution conversion processing section 21, a color conversion processing section 22, a halftone processing section 23, a rasterizing processing section 24 and a thinning processing section 25.

The resolution conversion processing section 21 converts the resolution of the image data output from the application program 10 into resolution that is equal to the printing resolution of the printer 200. The color conversion processing section 22 performs color conversion processing on the image data. The printer 200 used in the embodiment uses colors of cyan (C), magenta (M), yellow (Y) and black (B) to print an image. The color conversion processing section 22 converts pixel values represented by RGB values into CMYK values. The halftone processing section 23 performs halftone processing on the converted pixel values to generate dot data. The halftone processing may use an error diffusion method or a dither method using a dither matrix. The printer 200 used in the embodiment is capable of forming dots (large dots, medium-sized dots and small dots) of three sizes. However, the printer 200 is not restricted to a printer that is capable of forming dots of three sizes. A printer that is capable of forming dots of one or more sizes can be applied to the printer 200. The rasterizing processing section 24 changes the order of the dot data obtained by the halftone processing to the order in which the dot data needs to be transferred to the printer 200. The thinning processing section 25 performs a thinning process (described later) on the dot data. The dot data subjected to the thinning process is temporarily stored in the output buffer 32 and then output to the printer 200 through the input/output interface section 130.

The printer 200 used in the embodiment is an inkjet printer that forms ink dots on a printing medium and prints an image on the printing medium. The printer 200 includes: a CPU 210; a memory 220; an input/output interface (I/F) section 230; a unit control circuit 240 that controls units on the basis of an instruction output from the CPU 210; a head unit 250; a carriage unit 260; and a transfer unit 270. The head unit 250 has a printing head (not shown) that outputs ink to a printing medium. The head unit 250 includes a plurality of nozzles that are provided for each ink and arranged in an auxiliary scanning direction. The head unit 250 intermittently outputs ink from each of the nozzles. The head unit 250 is mounted on the carriage unit 260. When the carriage unit 260 moves in a predetermined scanning direction (main scanning direction), the head unit 250 also moves in the main scanning direction. The head unit 250 intermittently outputs ink while moving in the main scanning direction so that a dot line extending in the main scanning direction is formed on a printing medium. In this specification, a main scanning line is also called a “raster line”.

The carriage unit 260 serves as a driving device and causes the head unit 250 to reciprocate in the main scanning direction. The carriage unit 260 holds the head unit 250 and an ink cartridge that stores ink. The ink cartridge is attachable to and detachable from the carriage unit 260. The transfer unit 270 serves as a driving device and transfers the printing medium for auxiliary scanning. The transfer unit 270 includes a paper feeding roller, a transfer motor, a transfer roller, a platen and a paper delivery roller (which are not shown). The printing head may be transferred in the auxiliary scanning direction instead of the printing medium.

### Example

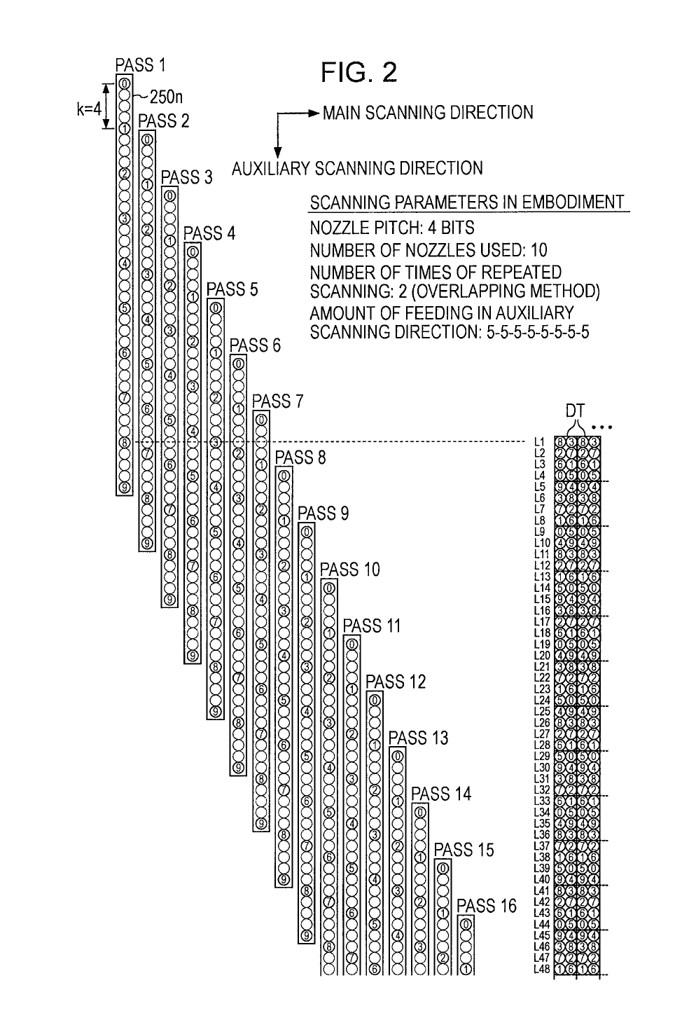

FIG. 2 is a diagram showing a dot recording method according to the embodiment. A nozzle array 250n included in the head unit 250 is shown on the left side of FIG. 2. The nozzle array 250n includes ten nozzles that supply one type of ink (e.g., black ink). Nozzle arrays for other types of ink are not shown in FIG. 2. The actual printer has several tens to several hundreds of nozzles for one type of ink. For convenience, the nozzle array that includes a small number of nozzles is shown in FIG. 2. Numbers (0 to 9) indicate the positions of the nozzles and are numbers (IDs) that identify the nozzles. A pitch k between adjacent two of the nozzles is 180 dpi, for example. A pitch between adjacent two of the pixels is 720 dpi, for example. In this case, the pitch k is 4 “dots”. In general, the pitch k is an integer of 2 or more. The nozzle array 250n records dots on a printing medium during main scanning performed in the main scanning direction (left-right direction of FIG. 2). In FIG. 2, a “pass” indicates a main scanning pass. Each of the numbers, which indicates the main scanning pass, is a pass number. The pass numbers are numbers that identify the main scanning passes that are performed. Every time the main scanning pass is performed, the nozzle array 250n moves in the auxiliary scanning direction (top-bottom direction of FIG. 2). Thus, the pass number of the main scanning pass is incremented by one by the movement of the nozzle array 250n. In this example, the amount by which the printing medium is fed in the auxiliary scanning direction is 5 dots for each main scanning pass. The positions of the nozzle array 250n, which correspond to sixteen main scanning passes, are shown in FIG. 2. In FIG. 2, it is assumed that the nozzle array 250n moves for convenience, although the printing medium actually moves.

Circles with numbers shown on the right side of FIG. 2 indicate ink dots that are to be recorded. The numbers in the circles indicate nozzle numbers. Symbols L1 to L48 indicate line numbers (consecutive numbers) of main scanning lines. The nozzle 8 and the nozzle 3 alternately record a dot for one pixel on the main scanning line L1. As apparent when referring to the left side of FIG. 2, the dot is recorded by the nozzle 8 on the main scanning line L1 in the main scanning pass having the pass number 1, and the dot is recorded by the nozzle 3 on the main scanning line L1 in the main scanning pass having the pass number 5. In this example, all dots on each main scanning line are recorded in two main scanning passes. In other words, all the dots on each main scanning line are recorded by two nozzles different from each other. This printing is called two-pass printing. In this specification, printing, in which main scanning is performed an N number of times and dot recording is performed on each main scanning line by an N number of nozzles, is called overlapping printing. An N number of the main scanning passes necessary to complete printing on each main scanning line can be set to any number of two or more. A manufacturing error of the printing head or an error in feeding of the printing medium in the auxiliary scanning direction may cause slight misalignment of recorded dots. In general, the reason that printing is performed on each raster line in multiple main scanning passes is that one line is printed by multiple different nozzles to suppress misalignment of recorded dots. The symbols L1 to L48 shown in FIG. 2 can be treated as numbers of raster lines arranged in the auxiliary scanning direction.

In the embodiment, each dot recording region DT that includes dots arranged in four rows and two columns is treated as a dot composition unit in which dot recording is performed. The order in which the dots are recorded is set for each dot recording region DT. In addition, the recording positions of the dots that are to be recorded are set for each dot recording region DT. Eight dots are arranged in four rows and two columns in each dot recording region DT. The dot recording is performed in eight main scanning passes (having the eight consecutive pass numbers) to record the dots that are included in the dot recording region DT so that nozzles that form ink dots are different for each main scanning pass. When the dot recording proceeds, different nozzles can simultaneously form the ink dots in the main scanning pass having the same pass number. For example, the dots are recorded in the main scanning pass having the pass number 8 by all the nozzles having nozzle numbers 0 to 9. In each dot recording region DT, dot recording is performed in the main scanning passes having eight consecutive pass numbers. The order of the eight consecutive pass numbers varies depending on the position of the dot recording region DT (or on the total number of performed main scanning passes). This is described later.

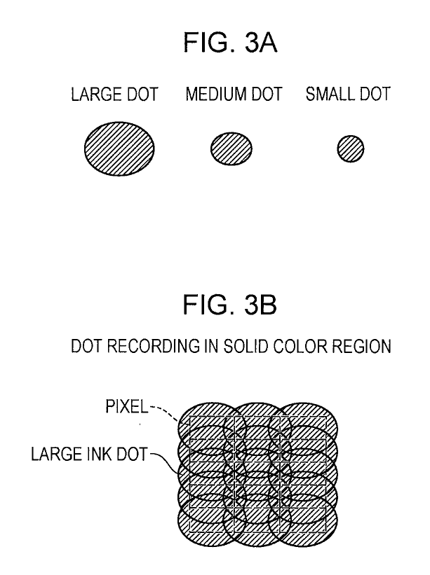

FIGS. 3A and 3B are diagrams showing the types of ink dots that can be formed by the inkjet printer. The printer is capable of forming the three types of ink dots (large dots, medium-sized dots and small dots) in a region for one pixel. FIG. 3A schematically shows the dots. The large dot is mainly used to print a solid color region and a high density region. The small dot is mainly used to print a low density region. The solid color region is printed only by means of the large dots in many cases. A highlighted region (extremely low density region) is printed only by means of the small dots in many cases. The medium-sized dot is used to print a medium density region and used more than the large and small dots. FIG. 3B shows a solid color region that includes 3×5 pixels and is printed by means of the large dots. Each pixel is shown by a broken line. The shape of each pixel may be rectangular or square. The large dot spreads in a wide range and completely covers one pixel. Large portions of the large dots placed in a central portion of the solid color region overlap large portions of the eight large dots placed in an edge portion of the solid color region. Normally, ink is output while the head moves in the main scanning direction (left-right direction of FIG. 2). Thus, each dot tends to spread in the left-right direction on the printing medium. When every other of the dots arranged in the main scanning direction is thinned in order to reduce the amount of ink consumed, degradation of the quality of an image is not so noticeable.

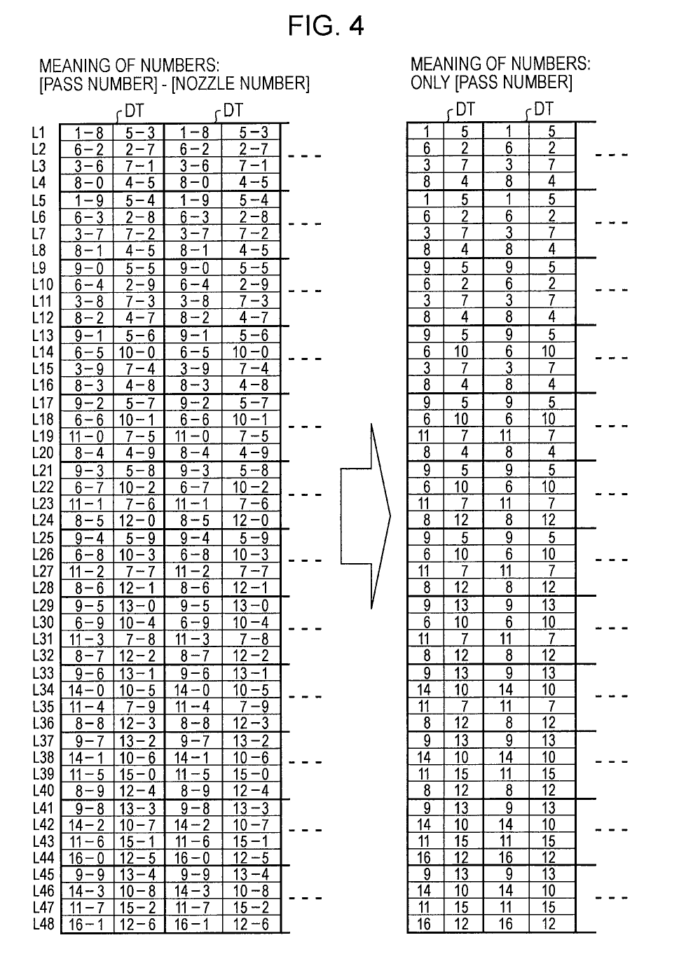

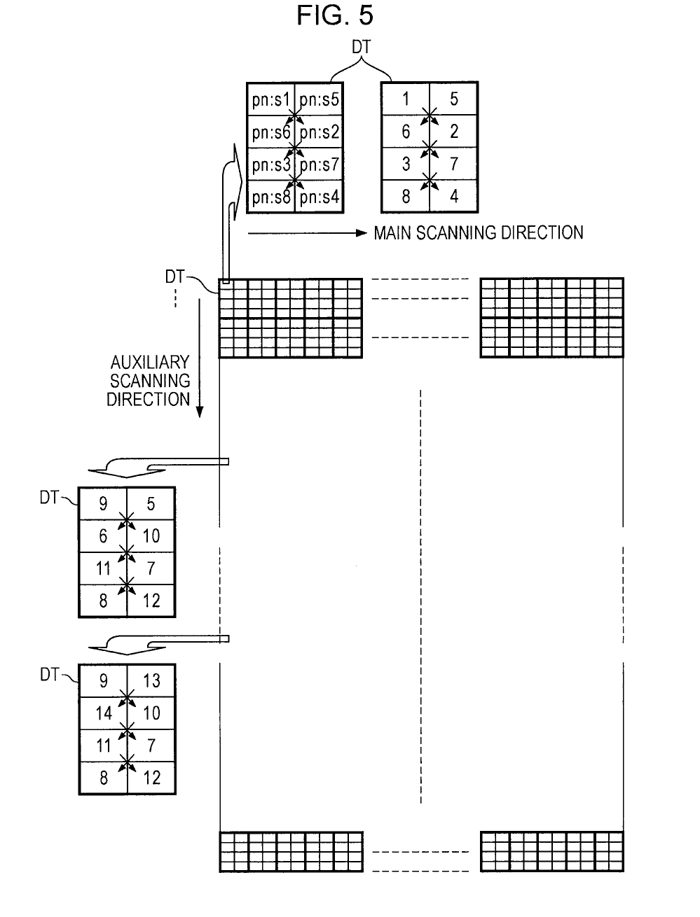

FIG. 4 is a diagram showing the dot recording method (described with reference to FIG. 2) in association with the pass numbers of the main scanning passes and the nozzle numbers. FIG. 5 is a diagram showing the order of the pass numbers in each dot recording region DT.

In FIG. 4, each frame represents one pixel (one dot). On the left side of FIG. 4, each frame represents the pass number of the main scanning pass on which the dot recording is performed, and the nozzle number of the nozzle used to perform the dot recording. On the right side of FIG. 4, each frame represents only the pass number of the main scanning pass for the pixel. As described above, each dot recording region DT includes dots arranged in four rows and two columns. The dot recording regions DT are arranged in the main and auxiliary scanning directions, as shown in FIG. 5. In FIG. 5, the pass numbers of the main scanning passes are shown.

The following describes the pass numbers of the main scanning passes in which the dots that are included in each dot recording region DT are recorded, and the order in which the dots included in the dot recording region DT are recorded. FIG. 5 shows the order in which the 4×2 dots included in the dot recording region DT are recorded. The dot recording order is set as follows. The dot recording order is associated with the pass numbers of the main scanning passes in which the dots included in the dot recording region DT are recorded. The dot recording order is incremented between dots located diagonally from each other in the dot region DT, as shown in FIG. 5. For example, the dots included in the dot recording region DT (in which the number of the main scanning lines is small) located on the upper left side of FIG. 5 are recorded in the main scanning passes having the pass numbers 1 to 8. In the dot recording region DT located on the upper left side of FIG. 5, the dot represented by the pass number 1 is first recorded. Then, the dots represented by the pass numbers 2, 3 and 4 are sequentially recorded. In terms of the dots represented by the pass numbers 1 to 4, the dot recording order is incremented between the dots located diagonally from each other. The remaining dots represented by the pass numbers 5, 6, 7 and 8 are sequentially recorded. In terms of the dots represented by the pass numbers 5 to 8, the dot recording order is incremented between the dots located diagonally from each other.

As the number of performed main scanning passes is increased, the pass numbers of the main scanning passes that are performed on the dot recording region DT are changed. In a dot recording region DT (different from the aforementioned dot recording region DT) shown in FIG. 5, a dot represented by the pass number 5 is first recorded. Then, dots represented by the pass numbers 6, 7 and 8 are sequentially recorded. Thus, the dot recording order is incremented between the dots located diagonally from each other in terms of the dots represented by the pass numbers 5, 6, 7 and 8. Then, remaining dots represented by the pass numbers 9, 10, 11 and 12 are sequentially recorded. Thus, the dot recording order is incremented between the dots located diagonally from each other in terms of the dots represented by the pass numbers 9, 10, 11 and 12. As the number of performed main scanning passes is further increased, a dot that is to be first recorded is not necessarily located in the top row of the dot recording region DT although eight pass numbers are arranged in the order of the pass numbers in the dot recording region DT. In this case, a dot represented by the pass number 7 is first recorded as shown in FIG. 5, for example. Then, a dot represented by the pass number 8 is recorded. Thus, the dot recording order is incremented between the dots (represented by the pass numbers 7 and 8) located diagonally from each other. The dots represented by the pass numbers 9, 10, 11 and 12 are then recorded according to the dot recording order so that the dot recording order is incremented in the aforementioned way. In this way, the dot recording order is incremented between the dots located diagonally from each other in the dot recording region DT that includes the dots arranged in four rows and two columns. Thus, the pass numbers representing the dots arranged in each column (extending in the auxiliary scanning direction) of the dot recording region DT are not consecutive. The order (dot recording order) of recording dots arranged in each of the entire columns (extending in the auxiliary scanning direction) of the dot recording region DT is not sequential.

The order in which the dots arranged in each of the columns (extending in the auxiliary scanning direction) of the dot recording region DT are recorded is not sequential. This results in dots adjacent to each other in the auxiliary scanning direction not being formed every three or more successive main scanning passes.

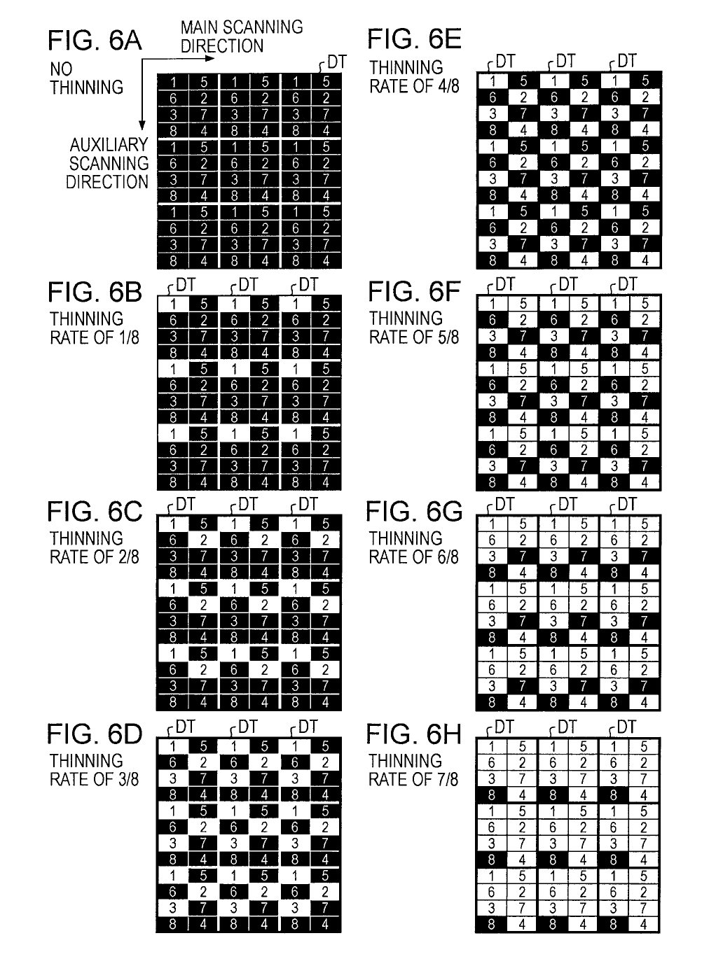

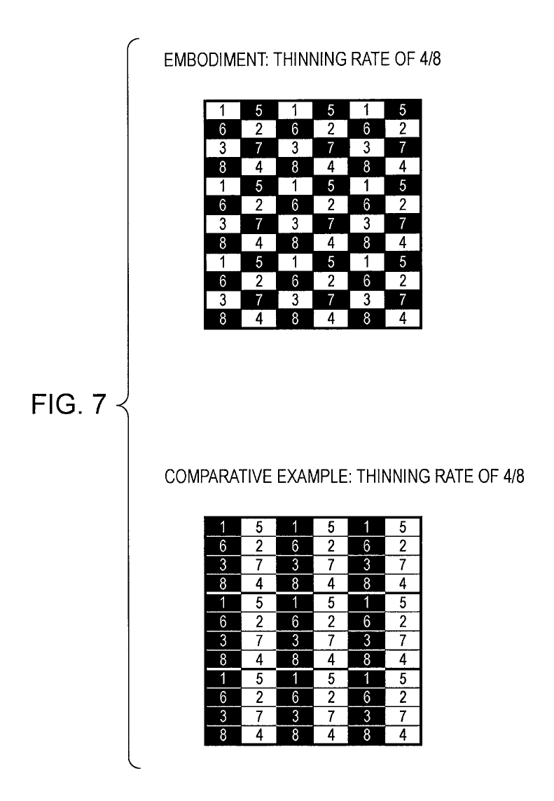

FIGS. 6A to 6H are diagrams showing the contents of a thinning process according to the embodiment. FIG. 7 is a diagram showing a difference between a thinning process in a comparative example and the thinning process according to the embodiment when a thinning rate used in the comparative example is the same as the thinning rate used in the embodiment. FIG. 6A shows dots that are recorded when the thinning process is not performed. In FIG. 6A, ink dots are recorded in the dot recording regions DT in the order of the pass numbers shown in FIG. 6A, and all the dots included in the dot recording regions DT are recorded. FIGS. 6B to 6H show dots that are recorded in the case where the thinning process is performed. The thinning process has the following features.

In the thinning process, at least one of the 4×2 (8) dots included in each dot recording region DT is thinned. When two or more dots included in the dot recording region DT are thinned, the dots that are to be sequentially recorded according to the dot recording order are thinned.

Since the thinning process having the above features is performed, the pass numbers (indicating the dot recording order) of the main scanning passes are consecutive in the main scanning lines that are adjacent to each other in the auxiliary scanning direction and are included in the dot recording region DT, and the amounts of errors in feeding of the printing medium in the auxiliary scanning direction can be reduced between the main scanning passes in which the dot recording is performed in the main scanning lines that are adjacent to each other in the auxiliary scanning direction. Typically, every time the feeding is performed to move the printing medium in the auxiliary scanning direction, a feeding error occurs. Thus, when the main scanning passes having the pass numbers that are largely different from each other are performed, dots that are not to be thinned or dots that are to be recorded are separated in the auxiliary scanning direction. The amounts of errors in feeding of the printing medium in the auxiliary scanning direction accumulate with every main scanning pass. To reduce the amount of error (that occurs in each main scanning pass) in feeding of the printing medium in the auxiliary scanning direction, the pass numbers of the main scanning passes in which the dot recording is performed in main scanning lines adjacent to each other in the auxiliary scanning direction in the dot recording region DT are set to be consecutive. This method can reduce the amount of error in feeding of the printing medium in the auxiliary scanning direction between the main scanning lines. This reduces accumulated misalignment of the ink deposited on main scanning lines adjacent to each other in the auxiliary scanning direction in the dot recording region DT.

Since the thinning process is performed in the aforementioned manner, at least one of the dots arranged in a single column and at least one of the dots arranged in a single row are not thinned when the thinning rate is set to 4/8 or less. In a comparative example (thinning rate of 4/8) shown in FIG. 7, when all dots arranged in the entire column are thinned, white spots are formed in the column and are noticeable. This results in excessive degradation in the quality of an image. When all dots arranged in the entire row are thinned, the same effect occurs. In the embodiment, when the thinning rate is 4/8 or less, at least one of the dots arranged in each column of the dot recording region DT and at least one of the dots arranged in each row of the dot recording region DT are not thinned. This suppresses degradation in the quality of an image. In the thinning process in the comparative example (thinning rate of 4/8) shown in FIG. 7, the dots arranged (at the positions of even-number pixels on the main scanning lines) in columns of even numbers are thinned. The thinning process in the comparative example is an example of the simplest thinning process.

The thinning process according to the embodiment is designed to prevent excessive degradation in the quality of an image in overlapping printing. The thinning process is also called an “overlapping-based dot thinning process”. In the embodiment, the overlapping-based dot thinning process shown in FIGS. 6B to 6H can be preformed on the dot recording region DT that includes the dots arranged in four rows and two columns.

Since each dot recording region DT includes the dots arranged in four rows and two columns in the embodiment, one to seven dots can be thinned in the dot recording region DT. The thinning rate is determined on the basis of the number of dots to be thinned. In FIG. 6B, one dot is thinned in the dot recording region DT. In this thinning process, the dot is thinned in the dot recording region DT in the main scanning pass having the pass number 1. That is, the dot that is included in the dot recording region DT and is to be first recorded according to the dot recording order is thinned. In FIGS. 6C to 6H, the number of dots to be thinned is increased from 2 to 7, and the dots are thinned in the dot recording order. In FIGS. 6C to 6G, while all the dots arranged in each column in the auxiliary scanning direction are not fully thinned, the dots that are not thinned are sequentially deposited and recorded on the main scanning lines adjacent to each other in the auxiliary scanning direction in the order of the pass numbers. In the embodiment, the dot recording order is set for the dot recording region DT and the dots are thinned in the order of the pass numbers. Thus, even when the thinning rate is a rate (e.g., ⅝ or 6/8) that is larger than the thinning rate used in the comparative example (in which the dots arranged in the even-number columns are thinned, refer to FIG. 7), the thinned dots are not continuously arranged in each of the entire columns of the dot recording region DT. In the embodiment, a white spot is not formed due to thinned dots continuously arranged in the entire column, and degradation in the quality of an image can be reliably suppressed.

In FIGS. 6A to 6H, the first pass number (pass number 1 in FIGS. 6A to 6H) in each dot recording region DT is regarded as the number (first thinning-targeted pass number) representing the dot that is to be first thinned. In FIG. 6A, the dots represented by the pass number 1 are thinned (thinning rate of ⅛). In FIG. 6B, the dots represented by the pass numbers 1 and 2 are thinned (thinning rate of 2/8). In FIG. 6C, the dots represented by the pass numbers 1 to 3 are thinned (thinning rate of ⅜). In FIG. 6D, the dots represented by the pass numbers 1 to 4 are thinned (thinning rate of 4/8). In FIG. 6E, the dots represented by the pass numbers 1 to 5 are thinned (thinning rate of ⅝). In FIG. 6F, the dots represented by the pass numbers 1 to 6 are thinned (thinning rate of 6/8). In FIG. 6H, the dots represented by the pass numbers 1 to 7 are thinned (thinning rate of ⅞). Since the first pass number is regarded as the first thinning-targeted pass number, the dot that is included in the dot recording region DT and is to be first recorded according to the dot recording order is first thinned. This method is performed in order to easily perform the thinning process with the thinning rate ranging from ⅛ to ⅞ on the dot recording region DT that includes the dots arranged in four rows and two columns. When the number of dots to be thinned is determined, a dot to be thinned is specified in ascending dot recording order from the dot that is included in the dot recording region DT and is to be first recorded according to the dot recording order. When a dot that is to be first thinned is the dot that is included in the dot recording region DT and is to be the last recorded according to the dot recording order, a dot to be thinned is specified in descending dot recording order from the dot that is included in the dot recording region DT and is to be the last recorded according to the dot recording order.

When the thinning rate is 6/8 or less, the first thinning-targeted pass number can be a pass number other than the first pass number. For example, when the thinning rate is 6/8, the dot represented by the pass number 1 or 2 is first thinned. Then, the dots represented by the pass numbers following the pass number of the thinned dot are sequentially thinned in the order of the pass numbers up to 6. When the thinning rate is ⅝, the dot represented by the pass number 1, 2 or 3 is first thinned. Then, the dots represented by the pass numbers following the pass number of the thinned dot are sequentially thinned in the order of the pass numbers up to 5. When the thinning rate is ⅛, the pass number of a dot to be thinned can be arbitrarily set. When the thinning rate is increased, the pass numbers of dots that are to be first thinned are set as long as the pass numbers of dots to be thinned are consecutive. Thus, the thinning process can be easily performed.

The pass numbers of dots to be thinned can be set as follows. It is assumed that an annular pass number array is formed by forming, in a loop, the pass numbers ranging from the first pass number (pass number 1 in the case of FIGS. 6A to 6H) to the last pass number (pass number 8 in the case of FIGS. 6A to 6H). The first thinning-targeted pass number is arbitrarily set. The annular pass number array (pass numbers of dots to be thinned) ranges from the arbitrarily set pass number to the pass number that is incremented from the arbitrarily set pass number by the number of dots to be thinned. For example, when the number of dots to be thinned is 4 and the first thinning-targeted pass number is set to the pass number 6, the pass numbers of dots to be thinned range from the pass number 6 to the pass number that is incremented by 4 from the pass number 6 in the pass number array. That is, the pass number 6, the pass number 7, the pass number 8 and the pass number 1 are arranged in this order in the pass number array.

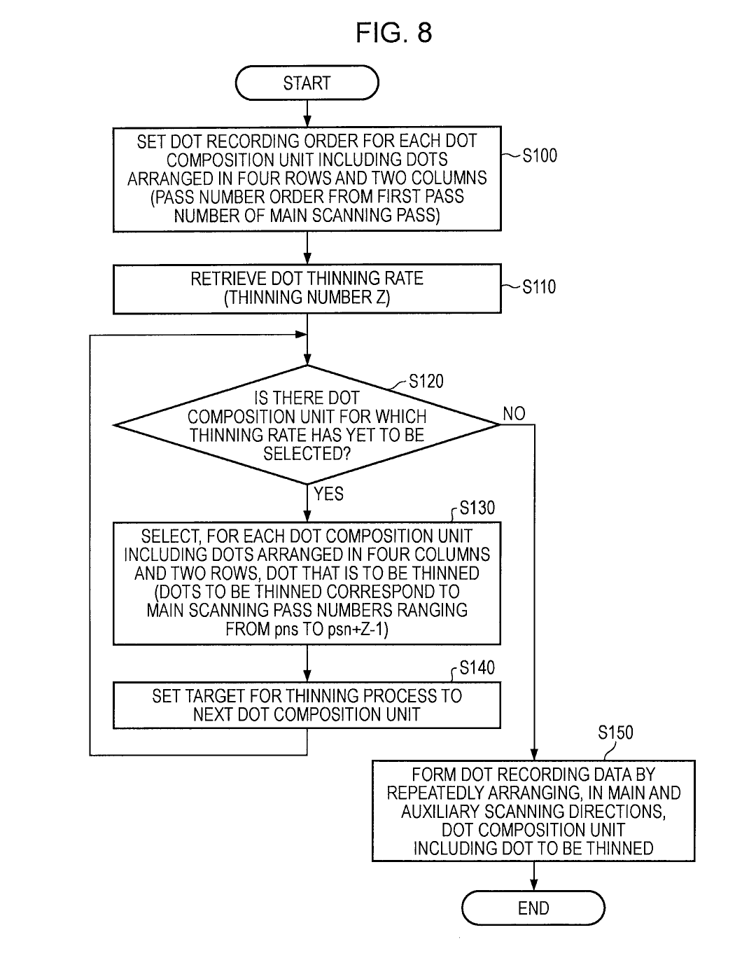

Next, a process that performs the thinning shown in FIGS. 6A to 6H is described below. FIG. 8 is a flowchart of a method for selecting, for each dot recording region DT, a dot to be thinned and generating dot recording data after the selection. The process shown in FIG. 8 is performed by the thinning processing section 25 (shown in FIG. 1). In step S100, the order (dot recording order) of recording dots (that are arranged in the main and auxiliary scanning directions and are to be printed) of the image data output from the printer driver 20 is set for each dot recording region DT that includes dots arranged in four rows and two columns. The dot recording order is incremented from the first pass number (among the pass numbers (of the main scanning passes) corresponding to the dots included in each dot recording region DT). In this case, the dot recording order is incremented between the dots located diagonally from each other as shown in FIG. 5. In this way, the dot recording order is set. In this case, the hardware configuration (refer to FIG. 2) of each nozzle array 250n included in the head unit 360 is predetermined. When the printer driver 20 receives the image data that is to be printed, the configuration of the dots of the image data can be detected. The dot recording order may be set for each dot recording region DT on the basis of the detected dot configuration in advance, and the result may be read in step S100.

Then, a thinning rate is retrieved as a thinning number Z (number of dots to be thinned) from the thinning rate input section 140 for each dot recording region DT in step S110. As described above, the thinning rate input section 140 is operated by the user to receive a thinning rate. In the embodiment, since the dot recording region DT includes the dots arranged in four rows and two columns, the thinning number Z that is in a range of 1 to 7 is retrieved. After the retrieval of the thinning number Z, it is determined whether or not there is a dot recording region DT for which a thinning rate has yet to be selected in step S120. When the determination in step S120 is negative, the following operations are terminated: the selection of dots to be thinned from among all the dot recording regions DT; and the setting of the dot recording order on the basis of the selection. Then, the process shown in FIG. 8 proceeds to step S150 and is then terminated.

On the other hand, when the determination in step S120 is affirmative, a dot that is to be thinned is selected for the dot recording region DT for which a thinning rate has yet to be selected in step S130. Dots represented by pass numbers ranging from the first pass number pns (among the pass numbers of the main scanning passes that are to be performed on the dot recording region DT) to the pass number ((pns+(Z−1)) that is incremented from the first pass number by the thinning number Z retrieved in step S120) are to be thinned. For example, when the thinning number Z is 1 (or the thinning rate is ⅛), the dots represented by the pass number 1 (pns=1) of the main scanning pass are thinned in the example shown in FIG. 6B. This scheme is described in association with the dot recording order. The dot that is to be first thinned is the dot that is to be first recorded according to the dot recording order among the dots included in the dot recording region DT.

When the thinning number Z is in a range of 2 to 7, dots represented by pass numbers ranging from the first pass number 1 (pns=1) to the pass number (pns+(Z−1)) are subjected to the thinning process. This scheme is described in association with the dot recording order. The dots that are subjected to the thinning process are specified in the dot recording order from the dot that is to be first recorded according to the dot recording order (among the dots included in the dot recording region DT). In this case, the number of dots that are subjected to the thinning process is equal to the thinning number Z. When the thinning number Z is 1, the pass number of a dot to be thinned may be a pass number other than the first pass number in the dot recording region DT as described above. In addition, pass numbers of dots to be thinned may be determined using the annular pass number array described above.

When a dot that is to be thinned in each dot recording region DT is selected on the basis of the thinning rate set by the user, a target for the thinning process is set to the next dot recording region DT in step S140. Then, the process shown in FIG. 8 is returned to step S120. When the determination in step S120 is negative, the following operations are terminated: the selection of dots to be thinned from among all the dot recording regions DT; and the setting of the dot recording order on the basis of the selection. In step S150, dot recording data is formed by repeatedly arranging, in the main and auxiliary scanning directions, the dot recording region DT corresponding to the selected dot that is to be thinned. The process shown in FIG. 8 is then terminated. Then, ink dots are recorded on the basis of the dot recording data including information on the thinned dots and the dot recording order. Thus, the thinning process having the aforementioned features is performed, as shown in FIGS. 6B to 6H. Therefore, the amount of ink used can be reduced without excessive degradation of the quality of the image.

As apparent from FIGS. 6A to 6H, the dot recording regions DT, in which dots to be thinned are the same and for which the same dot recording order is set, are arranged in the main scanning direction. The processes of steps S120 to S140 are performed on the dot recording regions DT arranged in the auxiliary scanning direction on the side of the first raster line, i.e., on the dot recording regions DT arranged in the left-side column shown in FIG. 5 in the auxiliary scanning direction, and parallel processing is performed to select dots that are to be thinned and are included in the other dot recording regions DT arranged in the main scanning direction. Thus, calculation loads caused by steps S120 to S140 can be reduced. In addition, a calculation load necessary to form the dot recording data in step S150 can be reduced. Therefore, processing for the selection and processing for the data formation can be performed at high-speed.

### MODIFIED EXAMPLES

The invention is not limited to the aforementioned example and embodiment and may be applied to various embodiments without departing from the gist of the invention. For example, the invention may be applied to the following modified examples.

### First Modified Example

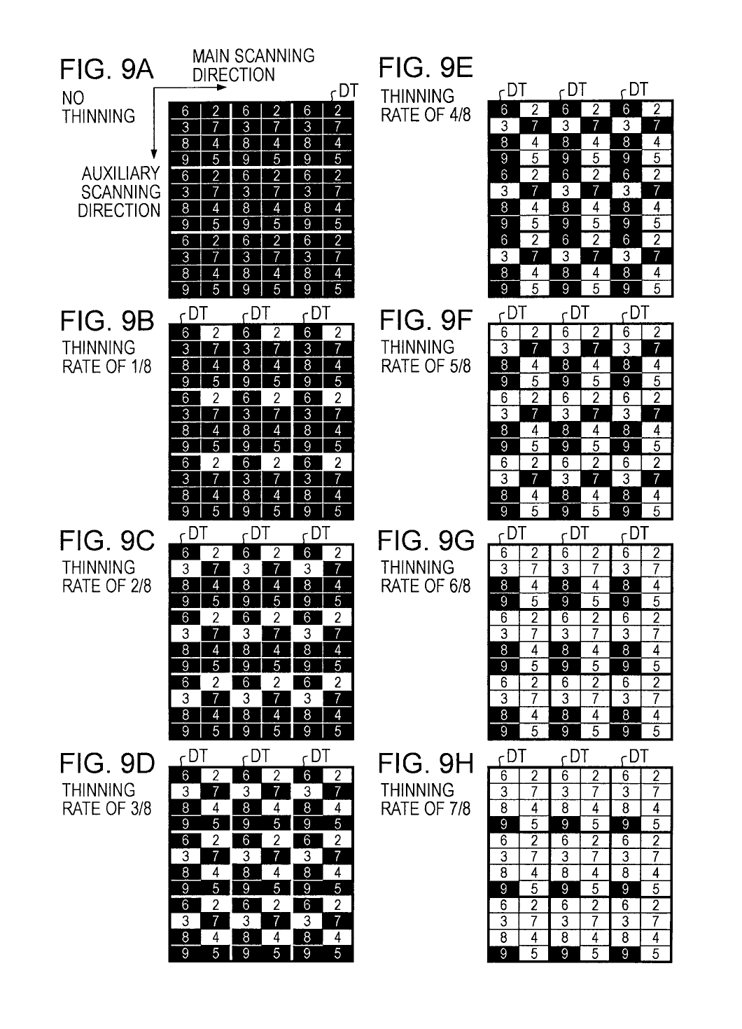

In each dot recording region DT including the dots arranged in four rows and two columns, the arrangement of the pass numbers and the arrangement of the dots corresponding to the pass numbers, i.e., the arrangement of the dots arranged in the dot recording order corresponding to the order of the pass numbers may be changed as follows, while the dot recording order that corresponds to the order of the pass numbers is incremented between dots located diagonally from each other (as shown in FIGS. 6A to 6H). FIGS. 9A to 9H correspond to FIGS. 6A to 6H and are diagrams showing the contents of a thinning process according to a first modified example of the invention.

In the first modified example shown in FIGS. 9A to 9H, the pass numbers that correspond to the dot recording order and are arranged in each of the columns (extending in the auxiliary scanning direction) of each dot recording region DT are not completely consecutive. Two of the pass numbers arranged in each of the columns of each dot recording region DT are consecutive. The recording of the dots represented by the pass numbers 2 to 9 is completed in eight main scanning passes in the order of the pass numbers 2 to 9. In terms of the dots arranged in the first and second rows and the dots arranged in the second and third rows, the order (dot recording order) of the pass numbers is incremented between the dots located diagonally from each other in the same way as the embodiment described above. However, the pass numbers (dot recording order) representing the dots arranged in the first column and the third and fourth rows are consecutive. In addition, the pass numbers (dot recording order) representing the dots arranged in the second column and the third and fourth rows are consecutive. In the thinning process with any of the thinning rates ⅛ to ⅝ (shown in FIGS. 9B to 9F) to thin the dots represented by the pass number 2, or the dots represented by the pass numbers 2 and 3, or the dots represented by the pass numbers 2 to 4, or the dots represented by the pass numbers 2 to 5, or the dots represented by the pass numbers 2 to 6 in the first modified example, the dot recording can be sequentially performed in the main scanning lines adjacent to each other in the auxiliary scanning direction so that the thinned dots are not continuously arranged in each of the entire columns (extending in the auxiliary scanning direction) of the dot recording regions DT. In the thinning process with any of the high thinning rates 6/8 and ⅞ to thin the dots represented by the pass numbers 2 to 7 or the dots represented by the pass numbers 2 to 8 in the first modified example, the dot recording cannot be sequentially performed in the main scanning lines adjacent to each other in the auxiliary scanning direction so that the thinned dots are not continuously arranged in the entire column (extending in the auxiliary scanning direction) of the dot recording regions DT. Thus, the thinned dots are continuously arranged in the entire column in the auxiliary scanning direction in the thinning process with any of the high thinning rates 6/8 and ⅞. In the thinning process with a high thinning rate in the first modified example, degradation in the quality of an image can be suppressed, and the amount of ink consumed can be reduced. The reduction in the amount of ink consumed can be prioritized in the thinning process with a high thinning rate in the first modified example.

### Second Modified Example

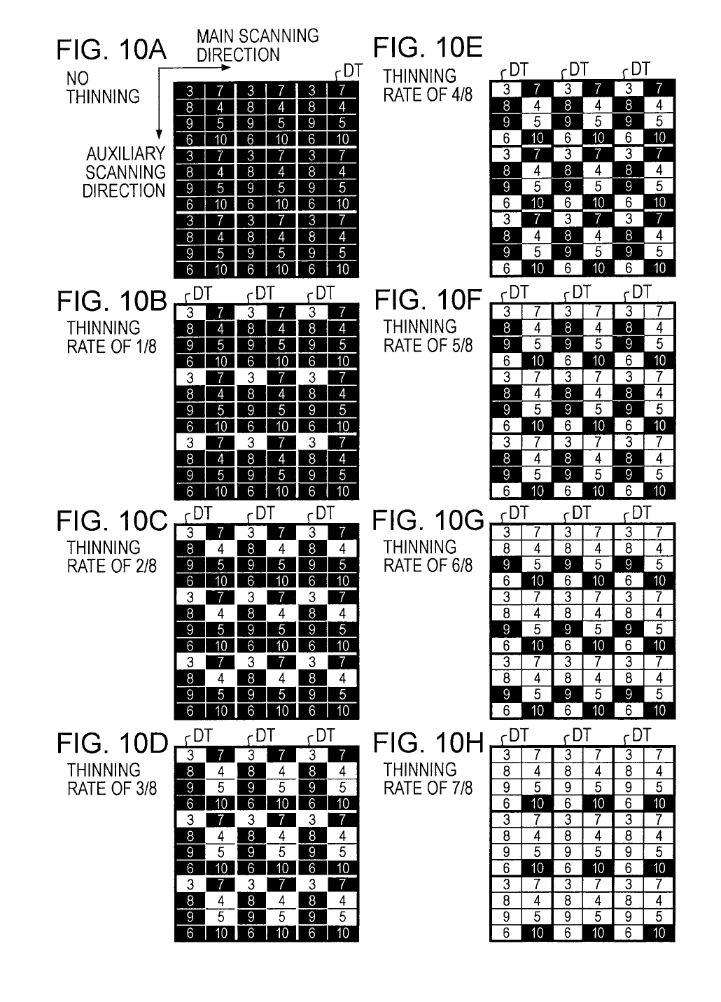

The arrangement of the dots that are included in each dot recording region DT and arranged in four rows and two columns can be changed as follows. FIGS. 10A to 10H are diagrams showing the contents of a thinning process according to a second modified example of the invention.

In the second modified example shown in FIGS. 10A to 10H, the pass numbers that correspond to the dot recording order and are arranged in each of the columns (extending in the auxiliary scanning direction) of each dot recording region DT are not completely consecutive. However, two of the pass numbers arranged in each of the columns of each dot recording region DT are consecutive. Specifically, the recording of the dots represented by the pass numbers 3 to 10 is completed in eight main scanning passes in the order of the pass numbers 3 to 10. In terms of the dots arranged in the first and second rows and the dots arranged in the second and third rows, the order (dot recording order) of the pass numbers is incremented between the dots located diagonally from each other in the same way as the example described above. However, the pass numbers (dot recording order) representing the dots arranged in the first column and the second and third rows are consecutive. In addition, the pass numbers (dot recording order) representing the dots arranged in the second column and the second and third rows are consecutive. In the thinning process with any of the thinning rates ⅛ to 6/8 (shown in FIGS. 10B to 10G) to thin the dots represented by the pass number 3, or the dots represented by the pass numbers 3 and 4, or the dots represented by the pass numbers 3 to 5, or the dots represented by the pass numbers 3 to 6, or the dots represented by the pass numbers 3 to 7, or the dots represented by the pass numbers 3 to 8 in the second modified example, the dot recording can be sequentially performed in the main scanning lines adjacent to each other in the auxiliary scanning direction so that thinned dots are not continuously arranged in each of the entire columns (extending in the auxiliary scanning direction) of the dot recording regions DT. In the thinning process with the high thinning rate of ⅞ to thin the dots represented by the pass numbers 3 to 9 in the first modified example, the dot recording cannot be sequentially performed in the main scanning lines adjacent to each other in the auxiliary scanning direction so that the thinned dots are not continuously arranged in each of the entire columns (extending in the auxiliary scanning direction) of the dot recording regions DT. In the thinning process with a high thinning rate in the first modified example, degradation in the quality of an image can be suppressed, and the amount of ink consumed can be reduced. The reduction in the amount of ink can be prioritized in the thinning process with a high thinning rate in the first modified example.

### Third Modified Example

The overlapping-based dot thinning process having the aforementioned features may be performed on the dot recording region DT in which only a medium-sized dot and a small dot are to be formed, in a different way from the overlapping-based dot thinning process that is performed on the dot recording region DT in which only large dots are to be formed. For example, when only large dots are to be formed in the dot recording region DT, the thinning rate can be selected from the range of ⅛ to ⅞ (shown in FIGS. 6B to 6H). When only a medium-sized dot and a small dot are to be formed in the dot recording region DT, the thinning rate is restricted to a range of ⅛ to 4/8 (shown in FIGS. 6B to 6E).

When only large dots are to be formed in the dot recording region DT, large portions of the dots adjacent to each other overlap each other, and whereby the quality of an image tends not to be excessively degraded due to the thinning, compared with overlapping of adjacent medium-sized dots and overlapping of adjacent small dots. On the other hand, small portions of the medium-sized dots adjacent to each other overlap each other, and small dots adjacent to each other hardly overlap each other. In these cases, the quality of an image tends to be noticeably degraded. Thus, the thinning rate is restricted to small values. When the user uses the thinning rate input section 140 to enter the thinning rate of ⅝ and only large dots are to be formed in the dot recording region DT, the thinning process is performed with the thinning rate of ⅝. On the other hand, when the user uses the thinning rate input section 140 to enter the thinning rate of ⅝ and only a medium-sized dot and a small dot are to be formed in the dot recording region DT, the thinning rate is restricted to the thinning rate of 4/8. The thinning rate is changed depending on the sizes of the dots. Even when large, medium and small dots are to be formed in any of all regions of the image data, the thinning rate is appropriately set (restricted) for each dot recording region DT including dots arranged in four rows and two columns. This suppresses degradation in the quality of an image.

### Fourth Modified Example

The embodiment describes the overlapping printing in which the number of times of the main scanning is 2. The invention, however, may be applied to overlapping printing in which the number of times of main scanning is not 2. For example, when the number of times of main scanning is 3 in the overlapping printing, each dot recording region DT includes dots arranged in four rows and three columns, and the aforementioned process is performed on each dot recording region DT. In terms of the raster lines continuously arranged in the auxiliary scanning direction, the process can be preformed in a similar way. Each dot recording region DT may include three raster lines or five raster lines. In this case, each dot recording region DT includes dots arranged in three rows and two columns or includes dots arranged in five rows and two columns.

### Fifth Modified Example

In the embodiment, the printing head moves in the main scanning direction. The printing medium may move in the main scanning direction instead of the printing head.

### Sixth Modified Example

The embodiment describes the inkjet printer. The invention, however, may be applied to another image recording device such as a facsimile or a copy machine. In addition, the invention may be applied to a color output device that is used to manufacture a color filter such as liquid crystal display; an electrode material output device that is used to form electrodes such as organic electroluminescent display or field emission display; and another color material device such as a bioorganic substance output device that is used to manufacture a biochip. In this specification, the printing head corresponds to a recording head that is used for an image recording device such as a printer; a color material output head that is used to manufacture a color filter such as liquid crystal display; an electrode material output head that is used to form electrodes organic electroluminescent display or field emission display; or a bioorganic substance output head that is used to manufacture a biochip. The printing medium or dot recording medium, which is used in the invention, is not restricted to a paper and indicates a medium on which dots are formed.

What is claimed is:

1. A storage medium storing a computer program that can be read by a computer, wherein
the computer program causes the computer to generate dot recording data that is used in order for a dot recording device to perform dot recording and is supplied to the dot recording device that alternately performs, on the basis of the dot recording data, a main scanning pass to record a dot on a recording medium while moving an output head in a main scanning direction, the output head having a plurality of nozzles arranged in an auxiliary scanning direction, and a transfer operation to move the recording medium in the auxiliary scanning direction and that forms, on the recording medium, raster lines that extend in the main scanning direction and are arranged in the auxiliary scanning direction;
when an M×N number of dots that are arranged in an M number of the raster lines and an N number of columns in a dot recording region are to be recorded in an M×N number of main scanning passes, the computer program causes the computer to perform a function of selecting, in the order in which the dots are recorded and on the basis of a thinning rate and of data on set recording positions of the dots that are to be recorded in the main scanning passes, a dot to be thinned from among the M×N number of dots included in the dot recording region so that the order in which dots arranged in each of the entire columns of the dot recording region in the auxiliary scanning direction are recorded is not sequential, each of M and N being an integer of two or more, the M number of raster lines being continuously arranged in the auxiliary scanning direction, the N number of columns being continuously arranged in the main scanning direction;
the computer program causes the computer to perform a function of performing a thinning process on the dot to be thinned to thin the dot and prevent the dot from being recorded; and
the computer program causes the computer to perform a function of forming the dot recording data by repeatedly arranging, in the main and auxiliary scanning directions, the dot recording region including the dot that is selected in the order in which the dots are recorded and is to be thinned.

2. The storage medium according to claim 1, wherein
the computer program causes the computer to perform a function of sequentially selecting the dot to be thinned in ascending dot recording order from the dot that is included in the dot recording region and is to be first recorded according to the order in which the dots are recorded or in descending dot recording order from the dot that is included in the dot recording region and is to be the last recorded according to the order in which the dots are recorded.

3. The storage medium according to claim 2, wherein
the computer program causes the computer to perform a function of forming the dot recording data by repeatedly arranging, in the main and auxiliary scanning directions, the dot recording region including the dot that is selected in the order in which the dots are recorded and is to be thinned and that outputs the generated dot recording data to the dot recording device.

4. The storage medium according to claim 1, wherein
the computer program causes the computer to perform a function of setting the recording positions of the dots that are to be recorded in the main scanning passes.

5. The storage medium according to claim 1, wherein
the thinning rate is set by a user.

6. The storage medium according to claim 1, wherein
the thinning rate is set by a user;
the computer program causes the computer to perform a function of setting the recording positions of the dots that are to be recorded in the main scanning passes;
the computer program causes the computer to perform a function of sequentially selecting the dot to be thinned in ascending dot recording order from the dot that is included in the dot recording region and is to be first recorded according to the order in which the dots are recorded or in descending dot recording order from the dot that is included in the dot recording region and is to be the last recorded according to the order in which the dots are recorded; and
the computer program causes the computer to perform a function of forming the dot recording data by repeatedly arranging, in the main and auxiliary scanning directions, the dot recording region including the dot that is selected in the order in which the dots are recorded and is to be thinned and that outputs the generated dot recording data to the dot recording device.

7. A dot recording method comprising:
alternately performing, on the basis of dot recording data, a main scanning pass to record a dot on a recording medium while moving an output head in a main scanning direction, the output head having a plurality of nozzles arranged in an auxiliary scanning direction, and a transfer operation to move the recording medium in the auxiliary scanning direction and forming, on the recording medium, raster lines that extend in the main scanning direction and are arranged in the auxiliary scanning direction;
when an M×N number of dots that are arranged in an M number of the raster lines and an N number of columns in a dot recording region are to be recorded in an M×N number of the main scanning passes, selecting, in the order in which the dots are recorded and on the basis of a thinning rate and of data on set recording positions of the dots that are to be recorded in the main scanning passes, a dot to be thinned from among the M×N number of dots included in the dot recording region so that the order in which dots arranged in each of the entire columns of the dot recording region in the auxiliary scanning direction are recorded is not sequential, each of M and N being an integer of two or more, the M number of raster lines being continuously arranged in the auxiliary scanning direction, the N number of columns being continuously arranged in the main scanning direction;
performing a thinning process on the dot to be thinned to thin the dot and prevent the dot from being recorded; and
forming the dot recording data by repeatedly arranging, in the main and auxiliary scanning directions, the dot recording region including the dot that is selected in the order in which the dots are recorded and is to be thinned.

8. The dot recording method according to claim 7, further comprising
sequentially selecting the dot to be thinned in ascending dot recording order from the dot that is included in the dot recording region and is to be first recorded according to the order in which the dots are recorded or in descending dot recording order from the dot that is included in the dot recording region and is to be the last recorded according to the order in which the dots are recorded.

9. The dot recording method according to claim 7, further comprising
setting the recording positions of the dots that are to be recorded in the main scanning passes.

10. The dot recording method according to claim 7, further comprising
setting the thinning rate by a user.

11. The dot recording method according to claim 7, further comprising:
setting the thinning rate by a user;
setting the recording positions of the dots that are to be recorded in the main scanning passes; and
sequentially selecting the dot to be thinned in ascending dot recording order from the dot that is included in the dot recording region and is to be first recorded according to the order in which the dots are recorded or in descending dot recording order from the dot that is included in the dot recording region and is to be the last recorded according to the order in which the dots are recorded.

12. A dot recording device that alternately performs, on the basis of dot recording data, a main scanning pass to record a dot on a recording medium while moving an output head in a main scanning direction, the output head having a plurality of nozzles arranged in an auxiliary scanning direction, and a transfer operation to move the recording medium in the auxiliary scanning direction and forms, on the recording medium, raster lines that extend in the main scanning direction and are arranged in the auxiliary scanning direction, comprising:
a dot recording setting section that sets recording positions of dots that are to be recorded in main scanning passes so that the order in which dots arranged in each entire column of a dot recording region in the auxiliary scanning direction are recorded is not sequential when an M×N number of the dots that are arranged in an M number of the raster lines and an N number of the columns in the dot recording region are to be recorded in an M×N number of the main scanning passes, each of M and N being an integer of two or more, the M number of raster lines being continuously arranged in the auxiliary scanning direction, the N number of columns being continuously arranged in the main scanning direction;
a thinning processing section that performs a thinning process on a dot to be thinned to thin the dot and prevent the dot from being recorded; and
a dot data generator that generates the dot recording data subjected to the setting by the dot recording setting section and to the thinning process by the thinning processing section, wherein
the thinning processing section selects, in the order in which the dots are recorded and on the basis of a thinning rate, the dot to be thinned from among the M×N number of dots included in the dot recording region; and
the dot data generator forms the dot recording data by repeatedly arranging, in the main and auxiliary scanning directions, the dot recording region including the dot that is selected in the order in which the dots are recorded and is to be thinned.

13. The dot recording device according to claim 12, wherein
the thinning processing section sequentially selects the dot to be thinned in ascending dot recording order from the dot that is included in the dot recording region and is to be first recorded according to the order in which the dots are recorded or in descending dot recording order from the dot that is included in the dot recording region and is to be the last recorded according to the order in which the dots are recorded.

14. The dot recording device according to claim 12, wherein
the thinning rate is set by a user.

15. The dot recording device according to claim 12 is an inkjet printer.

16. The dot recording device according to claim 12, wherein
the thinning rate is set by a user, and
the thinning processing section sequentially selects the dot to be thinned in ascending dot recording order from the dot that is included in the dot recording region and is to be first recorded according to the order in which the dots are recorded or in descending dot recording order from the dot that is included in the dot recording region and is to be the last recorded according to the order in which the dots are recorded.
